(19) United States
(12) Patent Application Publication
(10) Pub. No.: US 2017/0176881 A1
(43) Pub. Date: Jun. 22, 2017

(54) LIQUID DEVELOPER

(71) Applicant: SAKATA INX CORPORATION, Osaka (JP)

(72) Inventors: Katsutoshi OKAMOTO, Osaka (JP); Hirohito MAEDA, Osaka (JP); Tomoaki INOUE, Osaka (JP); Yuya WATANABE, Osaka (JP)

(21) Appl. No.: 15/115,603

(22) PCT Filed: Feb. 4, 2015
(86) PCT No.: PCT/JP2015/053085

§ 371 Date: Jul. 29, 2016

(30) Foreign Application Priority Data
Feb. 4, 2014 (JP) 2014-019837

(51) Int. Cl. G03G 9/125; G03G 9/13

(52) U.S. Cl. CPC G03G 9/125; G03G 9/131

(57) ABSTRACT

A liquid developer for electrophotography or electrostatic recording is obtained by dispersing, in an insulating solvent, colored resin particles obtained according to the coacervation method from at least a pigment, pigment dispersion agent and binder resin, wherein the insulating solvent has been mixed in such a way that aliphatic hydrocarbon solvent having 11 to 12 carbon atoms accounts for 8.0 to 20.0 percent by mass, and aliphatic hydrocarbon solvent having 17 to 30 carbon atoms accounts for 2.0 to 45.0 percent by mass, and a total of these aliphatic hydrocarbon solvents having 11 to 30 carbon atoms accounts for 99 percent by mass or more, relative to the total mass of insulating solvent, and also in such a way that the viscosity of the insulating solvent at 25° C. becomes 2.0 to 10.0 mPa·s.

### TECHNICAL FIELD

The present invention relates to a liquid developer for electrophotography or electrostatic recording used for printing presses, copiers, printers, facsimiles, etc.

### BACKGROUND ART

The electrophotography method is a method for forming a colored image characterized in that an electrostatic latent image is formed on a photosensitive surface and then a developer (generally called “toner”) constituted by colored resin particles is deposited to develop the image by utilizing the electrostatic attraction force or repulsive force, after which the developer is transferred onto a base material for printing and fixed by means of heat or pressure, an overview of which is provided below.

First, the entire surface of a photosensitive material characterized in that it is an insulator in a dark environment but changes to a conductor in a bright environment, is charged with electricity in a dark environment. Then, according to the image to be printed, areas corresponding to non-image parts (or image parts) of the photosensitive material are irradiated with light (charged with electricity) to cause the electric charges to disappear, thus selectively providing charged areas and non-charged areas on the surface of the photosensitive material to form an electrostatic latent image. Next, a developer constituted by colored resin particles is charged with electricity of the polarity opposite the electrical charges of the photosensitive material, so that it is deposited by means of electrostatic force (if the non-image parts are charged with electricity, the developer is charged with the electricity of the same polarity to be repulsive so that it is pushed into the image parts only), and the electrostatic latent image is developed as a result. Lastly, the developer is transferred from the surface of the photosensitive material to a base material for printing, after which heat or pressure is applied to fix the developer to form a colored image.

Such electrophotography method allows for a coloring agent to be deposited at any desired positions on a photosensitive material and therefore it is suitable, despite the printing speed being insufficient, for creating a small number of copies, down to a single copy, of a printed product (containing different images) compared to the method of using printing plates to deposit a coloring agent always at fixed locations. For this feature, the electrophotography method is utilized primarily for copiers, printers, facsimiles, etc., for business use.

Developers used under the electrophotography method are largely classified into dry developers in a powder state and liquid developers constituted by liquid in which powder is dispersed, where, dry developers have traditionally been used in most applications.

Using a developer of smaller particle size is advantageous in obtaining a high-definition printed product, but because the inter-adhesion force of particles increases as the particle size decreases and this makes it difficult to maintain appropriate fluidity, and also because scattering of powder presents a labor health issue (pneumoconiosis, etc.), the minimum particle size of dry developer is 5 μm or so.

On the other hand, liquid developers do not scatter and allow sufficient fluidity to be maintained because particles are dispersed in liquid. Accordingly, liquid developers can comprise particles smaller than 1 μm, which makes it easy to obtain high-quality images.

Additionally, for liquid developers, generally those made by dispersing colored resin particles containing pigment or other coloring agent, in an insulating solvent, are used.

Liquid developers in use are generally of the type where colored resin particles containing pigment or other coloring agent are dispersed in an electrically insulating solvent. Various types of methods are available to manufacture such liquid developers, including: (1) polymerization method (method whereby colored resin particles are formed by polymerizing monomer components in an electrically insulating solvent in which a coloring agent has been dispersed), (2) wet pulverization method (method whereby a coloring agent and resin are kneaded at the melting point of the resin or higher and then dry-pulverized and the obtained pulverized product is wet-pulverized in an electrically insulating solvent in the presence of a dispersion agent), and (3) coacervation method (deposition method) (method whereby a coloring agent, resin, solvent that dissolves the resin, and electrically insulating solvent that does not dissolve the resin, are mixed and then these solvents are removed from the mixed liquid to cause the resin dissolved in the mixed liquid to deposit in a manner encapsulating the coloring agent and causing the deposited colored resin particles to be dispersed in the electrically insulating solvent).

Liquid developers obtained by this coacervation method are constituted by colored resin particles whose shape is closer to a sphere and whose size is more uniform compared to liquid developers obtained by the wet pulverization method, and are therefore considered to provide good electrophoretic migration property, as well.

For insulating solvents used in coacervation, aliphatic hydrocarbons that do not disturb electrical latent image because their electrical resistance is in a range of 10¹¹ to 10¹⁶, and are also free of odor and toxicity, are used. However, liquid developers that use any commercially available aliphatic hydrocarbon alone have been unable to achieve the mutually exclusive performances of electrophoretic migration property and transferability onto a base material for printing.

Additionally, examples of insulating solvents that have been disclosed include those where liquid paraffin of 250 in weight-average molecular weight (equivalent to having 18 carbon atoms) and liquid paraffin of 800 in weight-average molecular weight (equivalent to having 57 carbon atoms) are mixed together and used (refer to Patent Literature 1, for example), and others where two types of aliphatic saturated hydrocarbon solvents are mixed together and used in such a way that one aliphatic saturated hydrocarbon having 11 to 16 carbon atoms accounts for 90 percent by mass or more and the other aliphatic saturated hydrocarbon having 11 to 16 carbon atoms accounts for 20 to 60 percent by mass (refer to Patent Literature 2, for example). When used as insulating solvent, the former has too high a viscosity, while the latter has too low a viscosity by contrast; in other words, neither has been able to achieve the mutually exclusive performances of electrophoretic migration property and good transferability onto a base material for printing.

### BACKGROUND ART LITERATURE

### Patent Literature

### Patent Literature 1: Japanese Patent Laid-open No. 2007-041162

### Patent Literature 2: Japanese Patent Laid-open No. 2013-057890

### SUMMARY OF THE INVENTION

### Problems to be Solved by the Invention

Accordingly, an object of the present invention is to provide a liquid developer for electrophotography or electrostatic recording, obtained by utilizing the coacervation method, wherein such liquid developer achieves good electrophoretic migration property as well as good transferability onto a base material for printing.

### Means for Solving the Problems

The inventors of the present invention studied in earnest to achieve the aforementioned object and consequently developed the present invention.

To be specific, the present invention is (1) a liquid developer obtained by dispersing, in an insulating solvent, colored resin particles obtained according to the coacervation method from at least a pigment, pigment dispersion agent, and binder resin, wherein the insulating solvent has been mixed in such a way that aliphatic hydrocarbon solvent having 11 to 12 carbon atoms accounts for 8.0 to 20.0 percent by mass, and aliphatic hydrocarbon solvent having 17 to 30 carbon atoms accounts for 2.0 to 45.0 percent by mass, and the total of these aliphatic hydrocarbon solvents having 11 to 30 carbon atoms accounts for 99 percent by mass or more, relative to the total mass of insulating solvent, and also in such a way that the viscosity of the insulating solvent at 25° C. becomes 2.0 to 10.0 mPa·s.

Additionally, the present invention is (2) a liquid developer according to (1), which is a liquid developer obtained by dispersing, in an insulating solvent, colored resin particles obtained according to the coacervation method from at least a pigment, pigment dispersion agent, and binder resin, wherein the insulating solvent has been mixed in such a way that aliphatic hydrocarbon solvent having 11 to 12 carbon atoms accounts for 10.0 to 20.0 percent by mass, and aliphatic hydrocarbon solvent having 17 to 30 carbon atoms accounts for 2.0 to 20.0 percent by mass, and the total of these aliphatic hydrocarbon solvents having 11 to 30 carbon atoms accounts for 99 percent by mass or more, relative to the total mass of insulating solvent, and also in such a way that the viscosity of the insulating solvent at 25° C. becomes 2.0 to 5.0 mPa·s.

Additionally, the present invention is (3) a liquid developer according to (1) or (2), wherein the pigment dispersion agent is a basic group-containing pigment dispersion agent and the binder resin is a binder resin containing acid group-containing resin.

Additionally, the present invention is (4) a liquid developer according to any one of (1) to (3), wherein the binder resin is a combination of binder resin whose acid value is less than 20 mg KOH/g and binder resin whose acid value is 20 to 250 mg KOH/g.

Additionally, the present invention is (5) a liquid developer according to any one of (1) to (4), wherein the viscosity of the liquid developer at 25° C. is 30 to 60 mPa·s.

Additionally, the present invention is (6) a liquid developer according to any one of (1) to (5), wherein the insulating solvent is a mixture of insulating solvent (A) which is constituted by aliphatic hydrocarbon solvent having 12 to 16 carbon atoms accounting for 90 percent by mass or more and aliphatic hydrocarbon solvent having 12 or less carbon atoms accounting for 20 percent by mass or less, and insulating solvent (B) which is constituted by aliphatic hydrocarbon solvent having 15 or more carbon atoms accounting for 99 percent by mass or more and aliphatic hydrocarbon solvent having 17 or more carbon atoms accounting for 60 percent by mass or more.

Additionally, the present invention is (7) a liquid developer according to any one of (1) to (6), wherein the colored resin particles are colored resin particles granulated by utilizing the coacervation method, in an insulating solvent, from at least a pigment, basic group-containing pigment dispersion agent, binder resin containing acid group-containing resin, and granulating aid.

Additionally, the present invention is (8) a liquid developer according to any one of (1) to (7), wherein the colored resin particles are dispersed in the insulating solvent using the particle dispersion agent.

### Effects of the Invention

By using a liquid developer obtained by dispersing, in an insulating solvent, colored resin particles obtained according to the coacervation method from at least a pigment, pigment dispersion agent, and binder resin, wherein the insulating solvent has been mixed in such a way that aliphatic hydrocarbon solvent having 11 to 12 carbon atoms accounts for 8.0 to 20.0 percent by mass, and aliphatic hydrocarbon solvent having 17 to 30 carbon atoms accounts for 2.0 to 45.0 percent by mass, and the total of these aliphatic hydrocarbon solvents having 11 to 30 carbon atoms accounts for 99 percent by mass or more, relative to the total mass of insulating solvent, and also in such a way that the viscosity of the insulating solvent at 25° C. becomes 2.0 to 10.0 mPa·s, or specifically by using a liquid developer whose insulating solvent has been mixed in such a way that aliphatic hydrocarbon solvent having 11 to 12 carbon atoms accounts for 10.0 to 20.0 percent by mass, and aliphatic hydrocarbon solvent having 17 to 30 carbon atoms accounts for 2.0 to 20.0 percent by mass, and the total of these aliphatic hydrocarbon solvents having 11 to 30 carbon atoms accounts for 99 percent by mass or more, relative to the total mass of insulating solvent, and also in such a way that the viscosity of the insulating solvent at 25° C. becomes 2.0 to 10.0 mPa·s or preferably 2.0 to 5.0 mPa·s, a liquid developer offering improved levels of electrophoretic migration property and good transferability onto a base material for printing can be obtained.

### MODE FOR CARRYING OUT THE INVENTION

The liquid developer proposed by the present invention is explained in detail below.

(Colored Resin Particles)

The colored resin particles used under the present invention may be particles obtained by the coacervation method or particles obtained by any other method. Whichever the case may be, it is necessary to coat the pigment with the resin without fail.

Use of the coacervation method is ideal because the obtained colored resin particles are shaped more like a sphere and their particle sizes also become uniform compared to when other methods are used. To allow the coloring agent to be encapsulated as the molten resin deposits, a condition is required under which the resin deposits stably at the surface of the coloring agent. Also, if the coloring agent remains un-encapsulated in the resin, the insulating solvent itself is colored and this causes color to develop in areas where there are no colored resin particles, and therefore a condition is also required under which the entire coloring agent is encapsulated in the resin particles. In addition, particle sizes may distribute widely and uniform particles may not be obtained if the coloring agent is not completely encapsulated in the resin particles and gets exposed at the surface.

(Pigment)

For the aforementioned pigment to be contained in the colored resin particles, any known inorganic pigment or organic pigment can be used. For the inorganic pigment, acetylene black, graphite, red iron oxide, chrome yellow, ultramarine blue, carbon black or titanium oxide is preferred, for example. Also, for the organic pigment, azo pigment, lake pigment, phthalocyanine pigment, isoindoline pigment, anthraquinone pigment, or quinacridone pigment is preferred, for example. Under the present invention, the content of any such pigment is not limited in any way; from the viewpoint of image density, however, preferably the pigment is contained by 5 to 70 percent by mass in the final colored resin particle, and by 2 to 20 percent by mass in the final liquid developer.

(Pigment Dispersion Agent)

For the pigment dispersion agent used to disperse the aforementioned pigment, any known pigment dispersion agent can be used.

It should be noted that the pigment dispersion agent dissolves in the organic solvent described later, but not in the insulating solvent.

Specific examples of the dispersion agent include anionic surface active agent, nonionic surface active agent, cationic surface active agent, amphoteric surface active agent, silicone surface active agent, fluorine surface active agent or other surface active agent and derivatives thereof, polyurethane resin, polyester resin, (poly)amine derivative constituted by (poly)amine compound with polyester introduced to its amino group and/or imino group, carbodiimide compound having polyester side chain, polyether side chain or polyacrylic side chain (International Patent Laid-open No. WO 03/076527), carbodiimide compound which has basic nitrogen-containing group and whose side chain has polyester side chain, polyether side chain or polyacrylic side chain (International Patent Laid-open No. WO 04/000950), carbodiimide compound with side chain having pigment adsorption part (International Patent Laid-open No. WO 04/003085), and other pigment dispersion resins of high molecular weight, among others.

Among the above, basic group-containing pigment dispersion agents are preferred.

Also, commercially available products of the pigment dispersion agent include BYK-160, 162, 164, 182 (manufactured by BYK), EFKA-47 (manufactured by EFKA), Ajisper PB-821, 822 (manufactured by Ajinomoto), and Solsperse 24000 (manufactured by Zeneca), for example. Under the present invention, these pigment dispersion agents can be used alone or two or more of them can be combined as necessary. The content of any such pigment dispersion agent is not limited in any way, but is preferably 10 to 100 parts by mass relative to 100 parts by mass of the pigment. If the content is less than 10 parts by mass, the colored resin particles may not disperse sufficiently in the colored resin particle dispersion product to be manufactured; if the content exceeds 100 parts by mass, on the other hand, printability may be affected. A more preferable lower limit of the content of the pigment dispersion agent is 20 parts by mass, while a more preferable upper limit of it is 60 parts by mass.

(Binder Resin)

For the binder resin, any known binder resin fixable onto paper, plastic film, or other adherend can be used.

It should be noted that the binder resin dissolves in the organic solvent described later, but not in the insulating solvent.

Specific examples of the binder resin include, for example, polyester resin, epoxy resin, ester resin, acrylic resin, alkyd resin, rosin modified resin or other resin, which can be used alone or two or more types may be combined as necessary. Among the above, polyester resin is preferred from the viewpoints of coating film resistance and printability. The content of binder resin is not limited in any way, but preferably it is 100 to 1000 parts by mass relative to 100 parts by mass of the pigment.

From the viewpoint of ease of granulation and charging of colored resin particles, preferably the acid group-containing resin below is contained in the binder resin.

Here, the binder resin may be constituted only by acid group-containing resin whose acid value is over 0 mg KOH/g but no more than 250 mg KOH/g, or by a combination of acid group-containing resin and acid group-free resin.

For the acid group-containing resin, acid group-containing resin whose acid value is over 0 mg KOH/g but no more than 20 mg KOH/g may be combined with acid group-containing resin whose acid value is over 20 mg KOH/g but no more than 250 mg KOH/g. In particular, combining acid group-free resin and/or resin whose acid value is over 0 mg KOH/g but no more than 20 mg KOH/g with acid group-containing resin whose acid value is over 20 mg KOH/g but no more than 250 mg KOH/g is preferable, and combining polyester resin whose acid value is over 0 mg KOH/g but no more than 20 mg KOH/g with acid group-containing copolymer resin whose acid value is over 20 mg KOH/g but no more than 250 mg KOH/g is more preferable.

For the acid group-free resin and resin whose acid value is over 0 but less than 20 mg KOH/g, any known binder resin fixable onto paper, plastic film, or other adherend can be used, such as polyester resin, epoxy resin, ester resin, acrylic resin, alkyd resin, rosin modified resin, or other resin, where any of these resins can be used alone or two or more types can be combined as necessary. Of these, polyester resin is preferred from the viewpoints of coating film resistance and printability. The content of resin whose acid value is 0 or more but less than 20 mg KOH/g is not limited in any way, but preferably it is 100 to 1000 parts by mass relative to 100 parts by mass of the pigment.

For the acid group-containing resin whose acid value is 20 or more but no more than 250 mg KOH/g, thermoplastic resin fixable onto printing paper or other adherend is preferred. Specific examples include, among others, ethylene-(meth)acrylate copolymer, ethylene-vinyl acetate copolymer, partially saponified ethylene-vinyl acetate copolymer, ethylene-(meth)acrylate ester copolymer, polyethylene resin, polypropylene resin or other olefin resin, thermoplastic saturated polyester resin, styrene-acrylic copolymer resin, styrene-acrylic modified polyester resin or other styrene resin, alkyd resin, phenolic resin, epoxy resin, rosin modified phenolic resin, rosin modified maleate resin, rosin modified fumarate resin, (meth)acrylate ester resin or other acrylic resin, vinyl chloride resin, vinyl acetate resin, vinylidene chloride resin, fluororesin, polyamide resin, polyacetal resin, etc., to which carboxyl group, sulfonic acid group, phosphoric acid group or other acid group has been introduced by any method where carboxylic acid compound is used as polymerization material or addition material, or by means of peroxide treatment, etc. Also, one type or two or more types of the foregoing may be used. The acid group-containing resin is preferably carboxyl group-containing resin, or more preferably carboxyl group-containing copolymer, or even more preferably styrene-acrylic copolymer.

The content of acid group-containing resin whose acid value is 20 to 250 mg KOH/g is not limited in any way, but it is contained by 0.1 to 10 percent by mass, or preferably by 0.5 to 5 percent by mass, or more preferably by 1 to 4 percent by mass, in the liquid developer.

By combining acid group-containing resin whose acid value is 20 to 250 mg KOH/g, the ease of granulation of colored resin particles by the coacervation method improves. As for the acid group-containing resin whose acid value is 20 or more but no more than 250 mg KOH/g, it is not preferable for its acid value to exceed 250 mg KOH/g because this may cause the electrophoretic migration property to drop.

(Granulating Aid)

For the granulating aid used to obtain colored resin particles, which is to improve the uniformity of the colored resin particles, any carbodiimide compound having at least one carbodiimide group and whose number-average molecular weight is 500 to 100,000 can be used.

Here, the compatibility of the main binder resin and acid group-containing resin must be increased by introducing a specific amount of the carbodiimide compound relative to the acid group-containing resin, at a time when the acid groups can react with the carbodiimide groups.

Among carbodiimide compounds, carbodiimide compounds whose side chain and/or main chain has a polyester chain and/or polyether chain of 200 to 10,000 in number-average molecular weight are preferred.

Carbodiimide compounds having at least one carbodiimide group are compounds whose molecule has at least one carbodiimide group, or specifically group expressed by —N═C═N—.

It should be noted that the granulating aid dissolves in the organic solvent described later, but not in the insulating solvent.

Carbodiimide compounds include carbodiimide compounds having isocyanate group, carbodiimide compounds obtained by causing the isocyanate group in an isocyanate group-containing carbodiimide compound to react with a compound that can react with the isocyanate group, and carbodiimide group-containing carbodiimide compounds obtained by causing the carbodiimide groups in a carbodiimide compound containing at least two or more carbodiimide groups to react with a compound that can react with the carbodiimide group.

Specific examples are as follows, among others:

(1) Carbodiimide compounds having isocyanate groups at both ends, obtained by putting a diisocyanate compound through decarbonation reaction (Carbodilite V-01, V-03, V-05, etc., all manufactured by Nisshinbo);

(2) Carbodiimide compounds obtained by extending the chain of a carbodiimide compound having isocyanate groups at both ends according to (1) using a chain extender that can react with the isocyanate group (2,4-dimethyl-1,5-pentane diol, methyl diethanol amine and other diol compounds, diamine compounds, hydrazine, etc.);

(3) Carbodiimide compounds whose main chain has a polyether chain and/or polyester chain, obtained by causing a carbodiimide compound having isocyanate groups at both ends according to (1) to react with a polyester compound with hydroxyl group of 200 to 10000 in number-average molecular weight (such as polyester compound with hydroxyl group, obtained by putting ε-caprolactone, γ-butyrolactone, etc., through ring-opening polymerization using a low-molecular-weight monool and/or low-molecular-weight diol compound as an initiator; polyester compound containing hydroxyl group, obtained by causing a low-molecular-weight diol compound to react with a low-molecular-weight carboxylic acid compound under abundant presence of a low-molecular-weight compound; polyester compound containing hydroxyl group, obtained by causing monoalcohol to react with hydroxy stearic acid, etc.) and/or polyether compound with hydroxyl group of 200 to 10000 in number-average molecular weight (such as polyether compound with hydroxyl group, obtained by putting alkylene oxide through addition reaction with a low-molecular-weight monool and/or low-molecular-weight diol compound, etc.); and

(4) Carbodiimide compounds whose side chain has a polyether chain and/or polyester chain, obtained by causing the isocyanate groups in a carbodiimide compound having isocyanate groups at both ends according to (1) and also having at least two or more carbodiimide groups, to react with low-molecular-weight alcohol and then causing such carbodiimide compound to react further with a polyester compound with carboxyl group of 200 to 10,000 in number-average molecular weight (such as polyester compound with hydroxyl group and carboxyl group, obtained by putting ε-caprolactone, γ-butyrolactone, etc., through ring-opening polymerization using mono- or poly-oxy carboxylic acid as an initiator; polyester compound with hydroxyl group and carboxyl group, obtained by putting hydroxy carboxylic acid through self-condensation, etc.) and/or polyether compound with carboxyl group of 200 to 10000 in number-average molecular weight (such as polyether compound with carboxyl group, obtained by putting alkylene oxide through addition reaction using mono- or poly-oxy carboxylic acid as an initiator).

Among the above, carbodiimide compounds whose main chain has a polyether chain and/or polyester chain are preferred.

Under the present invention, all number-average molecular weights were obtained based on the gel permeation chromatography (GPC) method (in equivalent polystyrene) using the Water 2690 system (manufactured by Waters) and Plgea 5μ MIXED-D column (manufactured by Polymer Laboratories).

For the content of granulating aid, preferably the granulating aid is blended in such a way that the equivalent weight of carbodiimide groups in the carbodiimide compound relative to the total equivalent weight of acid groups in the binder resin and acid group-containing resin as described below, expressed by “equivalent weight of carbodiimide groups/equivalent weight of acid groups,” becomes 0.01 or more but less than 1.00.

An equivalent carbodiimide weight less than 0.01 is not desirable as it will lead to limited benefits, while an equivalent weight more than 1.00 is not desirable, either, because the viscosity will increase and cause agitation failure during manufacturing and the particles will become non-uniform.

(Resin of −120° C. to −60° C. in Glass Transition Temperature and/or Wax)

To improve the friction resistance of the liquid developer, preferably the colored resin particles contain a resin and/or wax of −120° C. to −60° C. in glass transition temperature.

It should be noted that the resin and/or wax of −120° C. to −60° C. in glass transition temperature dissolves in the organic solvent described below, but not in the insulating solvent.

The aforementioned resin may be resin having the polyester structure and/or polyether structure, for example, but it is preferably at least one type or more selected from polyester polyol, polyether polyol and polyester polyether polyol, among others, of which polyester polyol is preferred.

The content of resin of −120° C. to −60° C. in glass transition temperature is adjusted to 1.0 to 5.0 percent by mass, or more preferably to 1.0 to 3.0 percent by mass, in the colored resin particle. So long as it is within a range of 1.0 to 5.0 percent by mass, the printed surface will not separate after development.

As for the wax, oxidized polyethylene wax whose acid value is in a range of 0.5 to 20 mg KOH/g is preferred. The wax is used preferably by a range of 0.1 to 10 percent by mass per 100 percent by mass of total solid content in the liquid developer.

For this oxidized polyethylene wax, preferably one treated in the presence of a compound with basic group is used in order to improve the electrophoretic migration property and improve the friction resistance of the printed product that has been printed with the liquid developer. For the oxidized polyethylene wax treated in the presence of a compound with basic group, one produced by mixing oxidized polyethylene and compound with basic group under agitation in an insulating solvent is used. The aforementioned agitation mixture may be produced by mixing oxidized polyethylene and a compound with basic group under agitation in an insulating solvent beforehand, or it may also be possible to have polyethylene wax already contained in the colored resin particles when they are formed by the coacervation method described below (where the pigment dispersion agent or particle dispersion agent is a dispersion agent with basic group (compound with basic group)) and then mix oxidized polyethylene and dispersion agent with basic group under agitation in an insulating solvent during the course of manufacturing.

(Insulating Solvent)

The insulating solvent does not dissolve at least the aforementioned binder resin, pigment dispersion agent, granulating aid, resin of −120° C. to −60° C. in glass transition temperature, and wax, while also having electrical insulation property, which has been mixed in such a way that aliphatic hydrocarbon having 11 to 12 carbon atoms accounts for 8.0 to 20.0 percent by mass, and aliphatic hydrocarbon solvent having 17 to 30 carbon atoms accounts for 2.0 to 45.0 percent by mass, and the total of these aliphatic hydrocarbon solvents having 11 to 30 carbon atoms accounts for 99 percent by mass or more, relative to the total mass of insulating solvent, or more preferably aliphatic hydrocarbon having 11 to 12 carbon atoms accounts for 10.0 to 20.0 percent by mass, and aliphatic hydrocarbon solvent having 17 to 30 carbon atoms accounts for 2.0 to 20.0 percent by mass, and the total of these aliphatic hydrocarbon solvents having 11 to 30 carbon atoms accounts for 99 percent by mass or more, relative to the total mass of insulating solvent.

It is also possible to use a mixture of insulating solvent (A) which is constituted by aliphatic hydrocarbon solvent having 12 to 16 carbon atoms accounting for 90 percent by mass or more and aliphatic hydrocarbon solvent having 12 or less carbon atoms accounting for 20 percent by mass or less, and insulating solvent (B) which is constituted by aliphatic hydrocarbon solvent having 15 or more carbon atoms accounting for 99 percent by mass or more and aliphatic hydrocarbon solvent having 17 or more carbon atoms accounting for 60 percent by mass or more, which are mixed in such a way that aliphatic hydrocarbon solvent having 11 to 12 carbon atoms accounts for 8.0 to 20.0 percent by mass, and aliphatic hydrocarbon solvent having 17 to 30 carbon atoms accounts for 2.0 to 45.0 percent by mass, and the total of these aliphatic hydrocarbon solvents having 11 to 30 carbon atoms accounts for 99 percent by mass or more, relative to the total mass of insulating solvent, or more preferably aliphatic hydrocarbon solvent having 11 to 12 carbon atoms accounts for 10.0 to 20.0 percent by mass, and aliphatic hydrocarbon solvent having 17 to 30 carbon atoms accounts for 2.0 to 20.0 percent by mass, and the total of these aliphatic hydrocarbon solvents having 11 to 30 carbon atoms accounts for 99 percent by mass or more, relative to the total mass of insulating solvent.

If the ratio of insulating solvent (A) and insulating solvent (B) is outside the aforementioned ranges, the mutually exclusive performances of electrophoretic migration property and transferability may not be achieved at the same time.

Specific examples of insulating solvent (A) include IP Solvent 2028 (manufactured by Idemitsu Petrochemical), Isopar M (manufactured by Exxon Chemical), and NAS-4 (manufactured by NOF), among others. Specific examples of insulating solvent (B) include IP Solvent 2835 (manufactured by Idemitsu Petrochemical), NAS-SH (manufactured by NOF), MORESCO White P-40 and MORESCO White P-55 (manufactured by MORESCO), among others.

The viscosity of the insulating solvent alone at 25° C. is 2.0 to 10.0 mPa·s, or preferably 2.0 to 5.0 mPa·s, or more preferably 3.0 to 5.0 mPa·s, or even more preferably 3.0 to 4.0 mPa·s. If the viscosity of the insulating solvent alone at 25° C. exceeds 10.0 mPa·s, the viscosity of the liquid developer may become too high; if the viscosity is less than 2.0 mPa·s, on the other hand, the transferability may drop.

(Particle Dispersion Agent)

The liquid developer may further contain particle dispersion agent to increase the dispersibility of colored resin particles.

It should be noted that the particle dispersion agent dissolves in the insulating solvent and also in the organic solvent described later.

The particle dispersion agent dissolves in the insulating solvent to increase the dispersibility of colored resin particles, and may be a reaction product of polyamine compound and hydroxy carboxylic acid self-condensation product, for example. When the liquid developer is manufactured using the coacervation method described later, the colored resin particles are dispersed in the insulating solvent in the co-presence of this particle dispersion agent and aforementioned acid group-containing resin, as this allows the dispersion stability of colored resin particles to increase in the insulating solvent. The charging characteristics and migration property of colored resin particles can also be improved.

Preferably the particle dispersion agent has an amine value of 5 to 300 mg KOH/g. So long as the amine value is within this range, the colored resin particles have good dispersion stability and also present excellent charging characteristics.

It should be noted that, in this Specification for the present application, the “amine value” refers to an equivalent weight (mg) in potassium hydroxide obtained by converting the amine value per 1 g of solid content of particle dispersion agent as measured using 0.1 N aqueous solution of hydrochloric acid according to the potentiometric titration method (such as COMTITE (Auto Titrator COM-900, Buret B-900, Tit-station K-900), manufactured by Hiranuma Sangyo).

The polyamine compound is not limited in any way and may be, for example, polyvinyl amine polymer, polyallyl amine polymer, polydiallyl amine polymer, diallyl amine-maleate copolymer, etc., as well as polymers being the aforementioned polymers containing polyaniline unit, polypyrrole unit, etc. The aforementioned polyamine compound may also be ethylene diamine or other aliphatic polyamine, cyclopentane diamine or other alicyclic polyamine, phenylene diamine or other aromatic polyamine, xylene diamine or other aromatic-aliphatic polyamine, hydrazine or derivative thereof, etc. Among these, polyallyl amine polymer is preferred.

The hydroxy carboxylic acid constituting the hydroxy carboxylic acid self-condensation product is not limited in any way and may be, for example, glycolic acid, lactic acid, oxy butyric acid, hydroxy valeric acid, hydroxy caproic acid, hydroxy caprylic acid, hydroxy capric acid, hydroxy lauric acid, hydroxy myristic acid, hydroxy palmitic acid, hydroxy stearic acid, ricinoleic acid, castor oil fatty acid, or hydrogenated product thereof. It is preferably hydroxy carboxylic acid having 12 to 20 carbon atoms, or more preferably 12-hydroxy carboxylic acid having 12 to 20 carbon atoms, or even more preferably 12-hydroxy stearic acid.

Favorable particle dispersion agents include, among others, reaction product of polyamine compound and hydroxy stearic acid self-condensation product, or specifically reaction product of polyallyl amine and 12-hydroxy stearic acid self-condensation product, reaction product of polyethylene polyamine and 12-hydroxy stearic acid self-condensation product, reaction product of dialkyl aminoalkyl amine and 12-hydroxy stearic acid self-condensation product, reaction product of polyvinyl amine and 12-hydroxy stearic acid self-condensation product, or other reaction product of polyamine compound and 12-hydroxy stearic acid self-condensation product. Commercially available products of the particle dispersion agent include, for example, Ajisper PB817 (manufactured by Ajinomoto) and Solsperse 11200, 13940, 17000, 18000 (manufactured by Lubrizol Japan), etc. Among these, reaction product of polyallyl amine and 12-hydroxy stearic acid self-condensation product is preferred, as it is suitable due to good particle dispersibility, as well as excellent charging characteristics, in its initial state and over long-term preservation.

Under the present invention, one type or two or more types of any such particle dispersion agent(s) may be used, and the content of particle dispersion agent is preferably 0.5 to 3.0 percent by mass in the liquid developer.

(Charge-Controlling Agent)

The liquid developer may further contain a charge-controlling agent, if necessary, in addition to the aforementioned materials.

The charge-controlling agent may be any of the two representative types of (1) and (2) explained below.

(1) Type that Coats the Surface of Colored Resin Particles with an Ionized Substance or Substance Capable of Adsorbing Ions

Suitable charge-controlling agents of this type include, for example, linseed oil, soybean oil or other oil, alkyd resin, halogenated polymer, aromatic polycarboxylic acid, acid group-containing water-soluble dye, aromatic polyamine oxidative condensation product, and the like.

(2) Type that Dissolves in an Insulating Solvent to Provide a Coexisting Substance Capable of Exchanging Ions with the Colored Resin Particles

Suitable charge-controlling agents of this type include, for example, cobalt naphthenate, nickel naphthenate, iron naphthenate, zinc naphthenate, cobalt octylate, nickel octylate, zinc octylate, cobalt dodecylate, nickel dodecylate, zinc dodecylate, cobalt 2-ethyl hexanoate or other metallic soaps, petroleum sulfonate metallic salt, metallic salt of sulfosuccinate ester or other sulfonate metallic salts, lecithin or other phospholipids, t-butyl salicylate metallic complex or other salicylate metallic salts, polyvinyl pyrrolidone resin, polyamide resin, sulfonate-containing resin, hydroxy benzoate derivative, and the like.

(Other Additives Used as Necessary)

The liquid developer can also be blended with a pigment dispersion aid and other additives, as necessary, in connection with its use for printing presses, copiers, printers, facsimiles, etc.

Next, how the liquid developer proposed by the present invention is manufactured per the coacervation method is explained.

The liquid developer proposed by the present invention can be manufactured per the coacervation method by means of known processes, such as those described in Japanese Patent Laid-open No. 2003-241439 and Re-publication of International Patent Laid-open Nos. WO 2007/000974, WO 2007/000975.

The manufacturing method of liquid developer is explained below in greater detail. It should be noted, however, that the manufacturing method explained below is only one example of a preferred embodiment of the present invention and that the present invention is not limited to this method.

It should be noted that the organic solvent used in the liquid developer manufactured according to the coacervation method below, is an organic solvent that dissolves the aforementioned binder resin, pigment dispersion agent, acid group-containing resin, resin of −120° C. to −60° C. in glass transition temperature, and a particle dispersion agent. Examples include tetrahydrofuran and other ethers, methyl ethyl ketone, cyclohexanone and other ketones, ethyl acetate and other esters, toluene, benzene, and other aromatic hydrocarbons. These may be used alone or two or more types may be used together.

It is also possible to use other known granulation methods instead of the coacervation method, in which case due attention must be paid to prevent the pigment from being exposed on the surface of the obtained resin particles.

The viscosity of the liquid developer at the time of printing is preferably 30 to 60 mPa·s, or more preferably 40 to 50 mPa·s. In particular, the viscosity of the liquid developer at 25° C. is preferably 30 to 60 mPa·s, or more preferably 40 to 50 mPa·s. If the viscosity of the liquid developer at 25° C. exceeds 60 mPa·s, the liquid developer is heated at the time of printing so that its viscosity at the time of printing becomes 30 to 60 mPa·s, and is used as mentioned above.

If the viscosity of the liquid developer at the time of printing exceeds 60 mPa·s, the electrophoretic migration property, friction resistance and fixing property may become poor due to too high a viscosity of the liquid developer; if the viscosity is less than 30 mPa·s, on the other hand, the transferability may drop.

The specific manufacturing method starts with mixing the pigment, pigment dispersion agent, and part of the organic solvent, after which an attritor, ball mill, sand mill, bead mill, or other media dispersion machine, or high-speed mixer, high-speed homogenizer, or other non-media dispersion machine is used to obtain a pigment dispersion liquid in which the pigment has been dispersed. Next, the binder resin, or more preferably binder resin containing acid group-containing resin, as well as resin of −120° C. to −60° C. in glass transition temperature, wax and other additives as necessary, and the remaining organic solvent, are added to this pigment dispersion liquid. Thereafter, more preferably the particle dispersion agent is added and then the insulating solvent is added under agitation using a high-speed shearing/agitation machine, to obtain a mixed liquid. It should be noted that, when the aforementioned pigment dispersion liquid is prepared, the pigment may be dispersed after the binder resin, resin of −120° C. to −60° C. in glass transition temperature, and wax have been added. Next, the organic solvent is distilled away while agitating the mixed liquid using a high-speed shearing/agitation machine, to obtain the liquid developer under the present invention. If the concentration of solid content in the obtained liquid developer is high, insulating solvent may be added to achieve the required concentration of solid content. Furthermore, charge-controlling agent and other additives may be added as necessary. The liquid developer proposed by the present invention can also be obtained by distilling away the organic solvent and adding the insulating solvent simultaneously.

For the aforementioned high-speed shearing/agitation machine, a homogenizer, homo-mixer, or other machine capable of applying agitation/shearing force can be utilized. Such machines vary in capacity, rotational speed, model, etc., but any machine can be used as deemed appropriate according to the production mode. If a homogenizer is used, preferably the rotational speed is 500 revolutions per minute (rpm) or above.

The liquid developer proposed by the present invention is explained more specifically below using examples; however, the present invention is not limited to these examples so long as the purpose and scope of the present invention are followed. It should be noted that, in the descriptions below, “part” and “percent” refer to “part by mass” and “percent by mass,” respectively, unless otherwise specified.

### <Pigment>

Acid carbon black of pH2.8

It should be noted that since cyan, magenta, and yellow pigment also can achieve effects that are similar to what are achieved with carbon black, the present invention omits descriptions for them.

### <Pigment Dispersion Agent>

PB821 (manufactured by Ajinomoto Fine-Chemical)

### <Granulating Aid>

Into a four-way flask equipped with a reflux cooling tube, nitrogen gas introduction tube, agitation bar, and thermometer, 1823 parts of Carbodilite V-01 (solid content 50%) and 2197 parts of polycaprolactone diol (Mw 2000) were introduced and held for 3 hours at approx. 110° C. to cause the isocyanate groups to react with the hydroxyl groups, after which toluene was distilled out under reduced pressure and then 3109 parts of methyl ethyl ketone was introduced to obtain a granulating aid (50% solution).

### <Particle Dispersion Agent>

PB817 (Reaction product of polyamine compound and hydroxy carboxylic acid condensation product, manufactured by Ajinomoto Fine-Chemical)

### <Binder Resin>

Polyester resin (iso/terephthalic acid, trimellitic aid, bisphenol A), Mw: 90,000, Tg: 64° C., AV: 5, OHV: 47

Monomers of the composition (mol ratios) specified below were put through polymerization reaction to obtain an acid group-containing copolymer resin.

Styrene/stearyl acrylate/acrylic acid=56/30/14
(Weight-average molecular weight 68000, Theoretical acid value 75 KOH mg/g)

### <Organic Solvent>

Methyl ethyl ketone (MEK)

### <Charge-Controlling Agent>

t-butyl salicylate chromium salt

### <Insulating Solvent>

Insulating solvent (A): IP Solvent 2028 (manufactured by Idemitsu Kosan), NAS-4 (manufactured by NOF), Isopar M (manufactured by Exxon)
Insulating solvent (B): IP Solvent 2835 (manufactured by Idemitsu Kosan), NAS-5H (manufactured by NOF), MORESCO White P-40 (manufactured by Matsumura Oil), MORESCO White P-55 (manufactured by Matsumura Oil)

TABLE 1
Distributions of Compounds in Insulating Solvents (A) and (B) by Number of Carbon Atoms

| | | IP2028 | NAS-4 | Isopar M | IP2835 | NAS-5H | P-40 | P-55 |
|---|---|---|---|---|---|---|---|---|
| Viscosity mPas@25° C. | | 2.8 | | 3.6 | 16.4 | | 46 | 13.8 |
| Boiling point range | | 213-262 | 210-255 | 218-257 | 277-353 | 255-340 | 277-318 | 310-423 |
| Distribution by number of | C12 | 16.5% | Approx. 20% | 14.0% | | | | |
| carbon atoms | C13 | 3.0% | | 27.0% | | | | |
| | C14 | | | 39.0% | | | | |
| | C15 | | | 20.0% | 2.0% | | 11.8% | 0.3% |
| | C16 | 80.5% | Approx. 80% | | 7.0% | Approx. 20% | 23.4% | 1.5% |
| | C17 | | | | 7.0% | | 30.9% | 5.0% |
| | C18 | | | | 9.0% | | 24.3% | 7.5% |
| | C19 | | | | 34.0% | | 7.0% | 9.0% |
| | C20 | | | | 19.0% | Approx. 60% | 2.0% | 11.0% |
| | C21 | | | | 8.0% | | 0.5% | 12.5% |
| | C22 | | | | 3.0% | | 0.1% | 14.5% |
| | C23 | | | | 7.0% | | | 16.0% |
| | C24 | | | | 4.0% | Approx. 20% | | 11.5% |
| | C25 | | | | | | | 5.0% |
| | C26 | | | | | | | 3.0% |
| | C27 | | | | | | | 1.5% |
| | C28 | | | | | | | 0.7% |
| | C29 | | | | | | | 0.3% |
| | C30 | | | | | | | 0.2% |
| | C31 | | | | | | | 0.1% |
| | C32 | | | | | | | 0.1% |
| | C33 | | | | | | | 0.1% |
| | C34 | | | | | | | 0.1% |
| | C35 | | | | | | | 0.1% |

### Example 1

IP Solvent 2028 and IP Solvent 2835 were used at 85/15 as insulating solvent.

After mixing 20.00 parts of pigment (acid carbon black of pH2.8), 8.00 parts of pigment dispersion agent (PB821, manufactured by Ajinomoto Fine-Chemical) and 72.00 parts of methyl ethyl ketone, the mixture was kneaded for 15 minutes in a paint shaker using steel beads of 5 mm in diameter, and then kneaded further for 2 hours in an Eiger Motor Mill M-250 (manufactured by Eiger Japan) using zirconia beads of 0.05 mm in diameter. To a mill base consisting of 25.00 parts of this kneaded product, 21.00 parts of acid group-containing polyester resin as binder resin, 5.00 parts of acid group-containing resin, 2.00 parts of granulating aid (solid content 50%), and 96.00 parts of methyl ethyl ketone, were added and the mixture was agitated under heating at 50° C.

Thereafter, 1.00 parts of particle dispersion agent was added and the mixture was agitated, which was then diluted, under agitation, with 55.25 parts of IP Solvent 2028 as insulating solvent and 9.75 parts of IP Solvent 2835 as insulating solvent, to obtain a mixed liquid. Next, using a system constructed by connecting a solvent distillation device to (a pressure reducing device of) a homogenizer comprised of a sealed agitation tank, the mixed liquid was agitated at high speed (rotational speed 5000 rpm) in the homogenizer, while at the same time the temperature of the mixed liquid was raised to 50° C. by a pressure reducing device, after which the pressure was reduced and methyl ethyl ketone was completely distilled out from the sealed agitation tank, followed by addition, under agitation, of 0.0026 parts of charge adjusting agent, to obtain the black liquid developer of Example 1.

### Example 2

The liquid developer of Example 2 was obtained in the same manner as in Example 1, except that IP Solvent 2835 constituting insulating solvent (B) was changed to NAS-5H.

### Example 3

The liquid developer of Example 3 was obtained in the same manner as in Example 1, except that IP Solvent 2835 constituting insulating solvent (B) was changed to MORESCO White P-40.

### Example 4

The liquid developer of Example 4 was obtained in the same manner as in Example 1, except that IP Solvent 2835 constituting insulating solvent (B) was changed to MORESCO White P-55.

### Example 5

IP Solvent 2028 and IP Solvent 2835 were used at 90/10 as insulating solvent.

After mixing 20.00 parts of pigment (acid carbon black of pH2.8), 8.00 parts of pigment dispersion agent (PB821, manufactured by Ajinomoto Fine-Chemical) and 72.00 parts of methyl ethyl ketone, the mixture was kneaded for 15 minutes in a paint shaker using steel beads of 5 mm in diameter, and then kneaded further for 2 hours in an Eiger Motor Mill M-250 (manufactured by Eiger Japan) using zirconia beads of 0.05 mm in diameter. To 25.00 parts of this kneaded product, 21.00 parts of acid group-containing polyester resin as binder resin, 5.00 parts of acid group-containing resin, 2.00 parts of granulating aid (solid content 50%), and 96.00 parts of methyl ethyl ketone, were added and the mixture was agitated under heating at 50° C.

Thereafter, 1.00 parts of particle dispersion agent was added and the mixture was agitated, which was then diluted, under agitation, with 58.50 parts of IP Solvent 2028 as insulating solvent and 6.50 parts of IP Solvent 2835 as insulating solvent, to obtain a mixed liquid. Next, using a system constructed by connecting a solvent distillation device to (a pressure reducing device of) a homogenizer comprised of a sealed agitation tank, the mixed liquid was agitated at high speed (rotational speed 5000 rpm) in the homogenizer, while at the same time the temperature of the mixed liquid was raised to 50° C. by a pressure reducing device, after which the pressure was reduced and methyl ethyl ketone was completely distilled out from the sealed agitation tank, followed by addition, under agitation, of 0.0026 parts of charge adjusting agent, to obtain the black liquid developer of Example 5.

### Example 6

IP Solvent 2028 and IP Solvent 2835 were used at 70/30 as insulating solvent.

After mixing 20.00 parts of pigment (acid carbon black of pH2.8), 8.00 parts of pigment dispersion agent (PB821, manufactured by Ajinomoto Fine-Chemical) and 72.00 parts of methyl ethyl ketone, the mixture was kneaded for 15 minutes in a paint shaker using steel beads of 5 mm in diameter, and then kneaded further for 2 hours in an Eiger Motor Mill M-250 (manufactured by Eiger Japan) using zirconia beads of 0.05 mm in diameter. To 25.00 parts of this kneaded product, 21.00 parts of acid group-containing polyester resin as binder resin, 5.00 parts of acid group-containing resin, 2.00 parts of granulating aid (solid content 50%), and 96.00 parts of methyl ethyl ketone, were added and the mixture was agitated under heating at 50° C.

Thereafter, 1.00 parts of particle dispersion agent was added and the mixture was agitated, which was then diluted, under agitation, with 45.50 parts of IP Solvent 2028 as insulating solvent and 19.50 parts of IP Solvent 2835 as insulating solvent, to obtain a mixed liquid. Next, using a system constructed by connecting a solvent distillation device to (a pressure reducing device of) a homogenizer comprised of a sealed agitation tank, the mixed liquid was agitated at high speed (rotational speed 5000 rpm) in the homogenizer, while at the same time the temperature of the mixed liquid was raised to 50° C. by a pressure reducing device, after which the pressure was reduced and methyl ethyl ketone was completely distilled out from the sealed agitation tank, followed by addition, under agitation, of 0.0026 parts of charge adjusting agent, to obtain the black liquid developer of Example 6.

### Comparative Example 1

Insulating solvent (A) constituted 100% by IP Solvent 2028 was used as insulating solvent.

After mixing 20.00 parts of pigment (acid carbon black of pH2.8), 8.00 parts of pigment dispersion agent (PB821, manufactured by Ajinomoto Fine-Chemical) and 72.00 parts of methyl ethyl ketone, the mixture was kneaded for 15 minutes in a paint shaker using steel beads of 5 mm in diameter, and then kneaded further for 2 hours in an Eiger Motor Mill M-250 (manufactured by Eiger Japan) using zirconia beads of 0.05 mm in diameter. To 25.00 parts of this kneaded product, 21.00 parts of acid group-containing polyester resin as binder resin, 5.00 parts of acid group-containing resin, 2.00 parts of granulating aid (solid content 50%), and 96.00 parts of methyl ethyl ketone, were added and the mixture was agitated under heating at 50° C.

Thereafter, 1.00 parts of particle dispersion agent was added and the mixture was agitated, which was then diluted, under agitation, with 65.00 parts of IP Solvent 2028 as insulating solvent, to obtain a mixed liquid. Next, using a system constructed by connecting a solvent distillation device to (a pressure reducing device of) a homogenizer comprised of a sealed agitation tank, the mixed liquid was agitated at high speed (rotational speed 5000 rpm) in the homogenizer, while at the same time the temperature of the mixed liquid was raised to 50° C. by a pressure reducing device, after which the pressure was reduced and methyl ethyl ketone was completely distilled out from the sealed agitation tank, followed by addition, under agitation, of 0.003 parts of charge-controlling agent, to obtain the black liquid developer of Comparative Example 1.

### Comparative Example 2

Insulating solvent (A) constituted 100% by NAS-4 was used as insulating solvent.

The liquid developer of Comparative Example 2 was obtained in the same manner as in Comparative Example 1, except that IP Solvent 2028 constituting the insulating solvent was changed to NAS-5H.

### Comparative Example 3

Insulating solvent (A) constituted 100% by Isopar M was used as insulating solvent.

The liquid developer of Comparative Example 3 was obtained in the same manner as in Comparative Example 1, except that IP Solvent 2028 constituting the insulating solvent was changed to Isopar M.

### Comparative Example 4

Insulating solvent (B) constituted 100% by IP Solvent 2835 was used as insulating solvent.

The liquid developer of Comparative Example 4 was obtained in the same manner as in Comparative Example 1, except that IP Solvent 2028 constituting the insulating solvent was changed to IP Solvent 2835.

### Comparative Example 5

Insulating solvent (B) constituted 100% by NAS-5H was used as insulating solvent.

The liquid developer of Comparative Example 5 was obtained in the same manner as in Comparative Example 1, except that IP Solvent 2028 constituting the insulating solvent was changed to NAS-5H.

### Comparative Example 6

Insulating solvent (B) constituted 100% by MORESCO White P-40 was used as insulating solvent.

The liquid developer of Comparative Example 6 was obtained in the same manner as in Comparative Example 1, except that IP Solvent 2028 constituting the insulating solvent was changed to MORESCO White P-40.

### Comparative Example 7

Insulating solvent (B) constituted 100% by MORESCO White P-55 was used as insulating solvent.

The liquid developer of Comparative Example 7 was obtained in the same manner as in Comparative Example 1, except that IP Solvent 2028 constituting the insulating solvent was changed to MORESCO White P-55.

<Evaluation Methods>

The liquid developers of Examples 1 to 6 and Comparative Examples 1 to 7 were evaluated according to the evaluation methods below, the results of which are shown in Table 1.

(Viscosity)

Viscosity at 25° C. was measured using a type E viscometer (5 rpm).

(Average Particle Size of Colored Resin Particles)

This was measured using a particle size distribution meter (9340-UPA150 manufactured by Microtrac).

(Electrophoretic Migration Property)

Particles were observed using an electrophoretic cell.

(Conditions—Distance Between Electrodes: 80 μm, Impression Voltage: 200 V)

(1) Electrophoretic Migration Property

◯: Particles migrated smoothly without aggregating together.

Δ: Particles migrated while forming aggregates.

(Friction Resistance Test)

Each liquid developer was supplied between the rollers, after which the impression voltage was applied to cause the particles in the liquid developer to migrate electrophoretically, and then the liquid developer on the roll on the negative electrode side was transferred onto paper and dried for 30 minutes in a 120° C. oven, which was followed by friction test conducted using a Gakushin-type friction resistance tester (120 g, 10 times).

◯: The printed surface remained free from scratches.

Δ: The area subjected to the friction test peeled by less than 10%.

X: The area subjected to the friction test peeled by 10% or more.

(Fixing Property)

Each liquid developer was supplied between the rollers, after which the impression voltage was applied to cause the particles in the liquid developer to migrate electrophoretically, and then the liquid developer on the roll on the negative electrode side was transferred onto paper and dried for 30 minutes in a 120° C. oven, which was followed by rubbing using an eraser for evaluation of fixing property.

◯: After the evaluation of fixing property, the density dropped by less than 30%.

Δ: After the evaluation of fixing property, the density dropped by 30% or more but less than 50%.

X: After the evaluation of fixing property, the density dropped by 50% or more.

(Transfer Ratio)

Each liquid developer was supplied between the rollers, after which the impression voltage was applied to cause the particles in the liquid developer to migrate electrophoretically, and then the liquid developer on the roll on the negative electrode side was transferred onto paper and the optical density (OD value) was measured using a Macbeth densitometer (product name: TD-931, manufactured by Macbeth).

TABLE 2
Composition of Mill Base

| Material | | Composition ratio (%) |
|---|---|---|
| Pigment | Carbon black | 20.000 |
| Pigment dispersion agent | PB821 | 8.000 |
| Good solvent | MEK | 72.000 |
| Subtotal | | 100.000 |

| | | | Example 1 | Example 2 | Example 3 | Example 4 | Example 5 | Example 6 |
|---|---|---|---|---|---|---|---|---|
| | | | IP2835: 15% | NAS-5H: 15% | P-40: 15% | P-55: 15% | IP2835: 10% | IP2835: 30% |
| Mill base | | | 25.00 | 25.00 | 25.00 | 25.00 | 25.00 | 25.00 |
| Acid group-containing resin | | | 5.00 | 5.00 | 5.00 | 5.00 | 5.00 | 5.00 |
| Polyester resin | | | 21.00 | 21.00 | 21.00 | 21.00 | 21.00 | 21.00 |
| Granulating aid | | | 2.00 | 2.00 | 2.00 | 2.00 | 2.00 | 2.00 |
| Particle | PB817 | Ajinomoto | 1.00 | 1.00 | 1.00 | 1.00 | 1.00 | 1.00 |
| dispersion | | Fine-Chemical | | | | | | |
| agent | | | | | | | | |
| Insulating | IP Solvent 2028 | Idemitsu Kosan | 55.25 | 55.25 | 55.25 | 55.25 | 58.50 | 45.50 |
| solvent | NAS-4 | NOF Corporation | | | | | | |
| | Isopar M | Exxon | | | | | | |
| | IP Solvent 2835 | Idemitsu Kosan | 9.75 | | | | 6.50 | 19.50 |
| | NAS-5H | NOF Corporation | | 9.75 | | | | |
| | MORESCO | Matsumura oil | | | 9.75 | | | |
| | White P-40 | | | | | | | |
| | MORESCO | Matsumura oil | | | | 9.75 | | |
| | White P-55 | | | | | | | |
| Good solvent | MEK | | 96.00 | 96.00 | 96.00 | 96.00 | 96.00 | 96.00 |
| Desolvent | MEK | | (115.00) | (115.00) | (115.00) | (115.00) | (115.00) | (115.00) |
| Charge | t-butyl salicylate chromium salt | | 0.0026 | 0.0026 | 0.0026 | 0.0026 | 0.0026 | 0.0026 |
| adjusting | | | | | | | | |
| agent | | | | | | | | |
| Total | | | 100.0026 | 100.0026 | 100.0026 | 100.0026 | 100.0026 | 100.0026 |
| Insulating | Viscosity | mPas | 3.6 | 3.5 | 3.1 | 3.9 | 3.3 | 5.5 |
| solvent | | | | | | | | |
| property | | | | | | | | |
| Toner | Viscosity | mPas | 47 | 45 | 40 | 50 | 42 | 60 |
| performance | (5 rpm) | | | | | | | |
| | Average | μm | 1.0 | 1.1 | 1.0 | 1.0 | 1.0 | 1.0 |
| | particle | | | | | | | |
| | size: d50 | | | | | | | |
| | Electrophoretic | Microscopic | ◯ | ◯ | ◯ | ◯ | ◯ | ◯ |
| | migration | observation | | | | | | |
| | property | | | | | | | |
| | Friction | | ◯ | ◯ | ◯ | ◯ | ◯ | ◯ |
| | resistance | | | | | | | |
| | Fixing property | Oven | ◯ | ◯ | ◯ | ◯ | ◯ | ◯ |
| | | evaluation | | | | | | |
| | Transfer ratio | OD value | 2.0 | 2.0 | 2.0 | 2.0 | 1.9 | 1.8 |

| | | | Comparative | Comparative | Comparative | Comparative | Comparative | Comparative | Comparative |
|---|---|---|---|---|---|---|---|---|---|
| | | | Example 1 | Example 2 | Example 3 | Example 4 | Example 5 | Example 6 | Example 7 |
| | | | IP2028: | NAS-4: | ISP-M: | IP2835: | NAS-5H: | P-40: | P-55: |
| | | | 100% | 100% | 100% | 100% | 100% | 100% | 100% |
| Mill base | | | 25.00 | 25.00 | 25.00 | 25.00 | 25.00 | 25.00 | 25.00 |
| Acid group-containing resin | | | 5.00 | 5.00 | 5.00 | 5.00 | 5.00 | 5.00 | 5.00 |
| Polyester resin | | | 21.00 | 21.00 | 21.00 | 21.00 | 21.00 | 21.00 | 21.00 |
| Granulating aid | | | 2.00 | 2.00 | 2.00 | 2.00 | 2.00 | 2.00 | 2.00 |
| Particle | PB817 | Ajinomoto | 1.00 | 1.00 | 1.00 | 1.00 | 1.00 | 1.00 | 1.00 |
| dispersion | | Fine- | | | | | | | |
| agent | | Chemical | | | | | | | |
| Insulating | IP Solvent | Idemitsu | 65.00 | | | | | | |
| solvent | 2028 | Kosan | | | | | | | |
| | NAS-4 | NOF | | 65.00 | | | | | |
| | | Corporation | | | | | | | |
| | Isopar M | Exxon | | | 65.00 | | | | |
| | IP Solvent | Idemitsu | | | | 65.00 | | | |
| | 2835 | Kosan | | | | | | | |
| | NAS-5H | NOF | | | | | 65.00 | | |
| | | Corporation | | | | | | | |
| | MORESCO | Matsumura | | | | | | 65.00 | |
| | White P-40 | oil | | | | | | | |
| | MORESCO | Matsumura | | | | | | | 65.00 |
| | White P-55 | oil | | | | | | | |
| Good solvent | MEK | | 96.00 | 96.00 | 96.00 | 96.00 | 96.00 | 96.00 | 96.00 |
| Desolvent | MEK | | (115.00) | (115.00) | (115.00) | (115.00) | (115.00) | (115.00) | (115.00) |
| Charge | t-butyl salicylate | | 0.0026 | 0.0026 | 0.0026 | 0.0026 | 0.0026 | 0.0026 | 0.0026 |
| adjusting | chromium salt | | | | | | | | |
| agent | | | | | | | | | |
| Total | | | 100.0026 | 100.0026 | 100.0026 | 100.0026 | 100.0026 | 100.0026 | 100.0026 |
| Insulating | Viscosity | mPas | 2.8 | 2.9 | 3.6 | 16.4 | 15.8 | 13.8 | 16.4 |
| solvent | | | | | | | | | |
| property | | | | | | | | | |
| Toner | Viscosity | mPas | 30 | 30 | 40 | 140 | 135 | 120 | 140 |
| performance | (5 rpm) | | | | | | | | |
| | Average | μm | 1.0 | 1.1 | 1.0 | 1.1 | 1.1 | 1.0 | 1.1 |
| | particle | | | | | | | | |
| | size: d50 | | | | | | | | |
| | Electrophoretic | Microscopic | ◯ | ◯ | Δ | Δ | Δ | Δ | Δ |
| | migration | observation | | | | | | | |
| | property | | | | | | | | |
| | Friction | | ◯ | ◯ | ◯ | Δ | Δ | Δ | Δ |
| | resistance | | | | | | | | |
| | Fixing | Oven | ◯ | ◯ | ◯ | Δ | Δ | Δ | Δ |
| | property | evaluation | | | | | | | |
| | Transfer ratio | OD value | 1.0 | 1.0 | 1.0 | 1.4 | 1.4 | 1.4 | 1.4 |

As shown in Table 3 above, Examples 1 to 6 conforming to the present invention provided liquid developers achieving excellent electrophoretic migration property, friction resistance, and fixing property, as well as high transfer ratio.

On the other hand, Comparative Examples 1 to 7, where only one of insulating solvent (A) and insulating solvent (B) under the present invention was used, only provided liquid developers characterized by either poor electrophoretic migration property, friction resistance, or fixing property and/or low transfer ratio.

1. A liquid developer obtained by dispersing, in an insulating solvent, colored resin particles obtained according to a coacervation method from at least a pigment, pigment dispersion agent and binder resin, wherein the insulating solvent has been mixed in such a way that aliphatic hydrocarbon solvent having 11 to 12 carbon atoms accounts for 8.0 to 20.0 percent by mass, and aliphatic hydrocarbon solvent having 17 to 30 carbon atoms accounts for 2.0 to 45.0 percent by mass, and a total of these aliphatic hydrocarbon solvents having 11 to 30 carbon atoms accounts for 99 percent by mass or more, relative to a total mass of insulating solvent, and also in such a way that a viscosity of the insulating solvent at 25° C. becomes 2.0 to 10.0 mPa·s.

2. A liquid developer according to claim 1, which is obtained by dispersing, in an insulating solvent, colored resin particles obtained according to a coacervation method from at least a pigment, pigment dispersion agent and binder resin, wherein the insulating solvent has been mixed in such a way that aliphatic hydrocarbon solvent having 11 to 12 carbon atoms accounts for 10.0 to 20.0 percent by mass, and aliphatic hydrocarbon solvent having 17 to 30 carbon atoms accounts for 2.0 to 20.0 percent by mass, and a total of these aliphatic hydrocarbon solvents having 11 to 30 carbon atoms accounts for 99 percent by mass or more, relative to a total mass of insulating solvent, and also in such a way that a viscosity of the insulating solvent at 25° C. becomes 2.0 to 5.0 mPa·s.

3. A liquid developer according to claim 1, wherein the pigment dispersion agent is a basic group-containing pigment dispersion agent and the binder resin is a binder resin containing acid group-containing resin.

4. A liquid developer according to claim 1, wherein the binder resin is a combination of binder resin whose acid value is less than 20 mg KOH/g and binder resin whose acid value is 20 to 250 mg KOH/g.

5. A liquid developer according to claim 1, wherein a viscosity of the liquid developer at 25° C. is 30 to 60 mPa·s.

6. A liquid developer according to claim 1, wherein the insulating solvent is a mixture of insulating solvent (A) which is constituted by aliphatic hydrocarbon solvent having 12 to 16 carbon atoms accounting for 90 percent by mass or more and aliphatic hydrocarbon solvent having 12 or less carbon atoms accounting for 20 percent by mass or less, and insulating solvent (B) which is constituted by aliphatic hydrocarbon solvent having 15 or more carbon atoms accounting for 99 percent by mass or more and aliphatic hydrocarbon solvent having 17 or more carbon atoms accounting for 60 percent by mass or more.

7. A liquid developer according to claim 1, wherein the colored resin particles are granulated colored resin particles obtained according to a coacervation method, in an insulating solvent, from at least a pigment, basic group-containing pigment dispersion agent, binder resin containing acid group-containing resin, and granulating aid.

8. A liquid developer according to claim 1, wherein the colored resin particles are dispersed in an insulating solvent using a particle dispersion agent.

9. A liquid developer according to claim 2, wherein the pigment dispersion agent is a basic group-containing pigment dispersion agent and the binder resin is a binder resin containing acid group-containing resin.

10. A liquid developer according to claim 2, wherein the binder resin is a combination of binder resin whose acid value is less than 20 mg KOH/g and binder resin whose acid value is 20 to 250 mg KOH/g.

11. A liquid developer according to claim 2, wherein a viscosity of the liquid developer at 25° C. is 30 to 60 mPa·s.

12. A liquid developer according to claim 2, wherein the insulating solvent is a mixture of insulating solvent (A) which is constituted by aliphatic hydrocarbon solvent having 12 to 16 carbon atoms accounting for 90 percent by mass or more and aliphatic hydrocarbon solvent having 12 or less carbon atoms accounting for 20 percent by mass or less, and insulating solvent (B) which is constituted by aliphatic hydrocarbon solvent having 15 or more carbon atoms accounting for 99 percent by mass or more and aliphatic hydrocarbon solvent having 17 or more carbon atoms accounting for 60 percent by mass or more.

13. A liquid developer according to claim 2, wherein the colored resin particles are granulated colored resin particles obtained according to a coacervation method, in an insulating solvent, from at least a pigment, basic group-containing pigment dispersion agent, binder resin containing acid group-containing resin, and granulating aid.

14. A liquid developer according to claim 2, wherein the colored resin particles are dispersed in an insulating solvent using a particle dispersion agent.

15. A liquid developer according to claim 3, wherein the binder resin is a combination of binder resin whose acid value is less than 20 mg KOH/g and binder resin whose acid value is 20 to 250 mg KOH/g.

16. A liquid developer according to claim 3, wherein a viscosity of the liquid developer at 25° C. is 30 to 60 mPa·s.

17. A liquid developer according to claim 3, wherein the insulating solvent is a mixture of insulating solvent (A) which is constituted by aliphatic hydrocarbon solvent having 12 to 16 carbon atoms accounting for 90 percent by mass or more and aliphatic hydrocarbon solvent having 12 or less carbon atoms accounting for 20 percent by mass or less, and insulating solvent (B) which is constituted by aliphatic hydrocarbon solvent having 15 or more carbon atoms accounting for 99 percent by mass or more and aliphatic hydrocarbon solvent having 17 or more carbon atoms accounting for 60 percent by mass or more.

18. A liquid developer according to claim 3, wherein the colored resin particles are granulated colored resin particles obtained according to a coacervation method, in an insulating solvent, from at least a pigment, basic group-containing pigment dispersion agent, binder resin containing acid group-containing resin, and granulating aid.

19. A liquid developer according to claim 3, wherein the colored resin particles are dispersed in an insulating solvent using a particle dispersion agent.

20. A liquid developer according to claim 4, wherein a viscosity of the liquid developer at 25° C. is 30 to 60 mPa·s.
